(19) United States
(12) Patent Application Publication
(10) Pub. No.: US 2003/0009434 A1
(43) Pub. Date: Jan. 9, 2003

(54) System and apparatus for public data availability

(75) Inventors: Jude Munn, Walnut Creek, CA (US); Clifford A. Chosy, Santa Rosa, CA (US)

Correspondence Address: CHARLES LOUIS THOEMING, 1990 N. CALIFORNIA BLVD., SUITE 720, WALNUT CREEK, CA, 94596, US

(73) Assignee: iSprocket, Inc.

(21) Appl. No.: 09/887,185

(22) Filed: Jun. 21, 2001

(51) Int. Cl. G06F 7/00

(52) U.S. Cl. 707/1

(57) ABSTRACT

Methods and apparatus for providing secure, real time access to and updating of particularly useful public information via the Internet for businesses and consumers. The present invention provides users with the ability to instantaneously maintain, control, monitor, and protect their respective public data through one or more hierarchical directory services housing all data items. Activity within the hierarchical directory services is realized through one or more relational data bases which interface with selectively customized user programs and adapt the particular user selected Internet system, informational applications, and security applications to the hierarchical directory services.

### CROSS-REFERENCES TO RELATED APPLICATIONS

None.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

The present invention relates to public data information systems employing electronic data interchange wherein the consumer or business can instantaneously, efficiently, and economically update their public information data base.

2. Description of the Related Art including Information Disclosed under 37 C.F.R. 1.97 and 1.98

A search of the prior art located the following United States patents which are believed to be representative of the present state of the prior art: U.S. Pat. No. 4,948,174, issued Aug. 14, 1990, U.S. Pat. No. 5,146,403, issued Sep. 8, 1992, and U.S. Pat. No. 5,953,427, issued Sep. 14, 1999.

### BRIEF SUMMARY OF THE INVENTION

In the present invention, the term “public data” refers to the particular information about a consumer or business that is normally available to the general population and is always available to businesses in an established business-to-consumer or business-to-business relationship. Specifically, this consumer and business information consists of:

1. consumer or business name(s);

2. physical (or postal) address(es), including business mail drop locations;

3. telephone number(s);

4. electronic mail address(es); and

5. uniform resource locator(s).

Businesses currently expend considerable resources and money to store and maintain their customers' public data, with each business possessing a separate, redundant copy of this same public data. Consumers expend significant amounts of time and energies to update their own public data, as well as store and maintain their associates' public data, typically creating redundant copies in various forms. In addition, each business faces similar obstacles when updating its own public data.

When a change to this public data occurs, there begins an arduous, time-consuming and costly process of updating each instance of this public data. Businesses today must budget for the inevitable exceptions that occur during this update process. A common result from this is the creation of an inconsistent condition, where some instances contain current public data and others contain the previous, voided public data. If a business that has many of these inconsistent instances should run a mission critical process against this data, the cost to reprocess the generated errors could be enormous.

For the consumer, these changes represent a time-consuming effort. They must notify every business, with which they have a relationship, of these changes. Often these changes can take days or even weeks to become effective; considering that the current methods available to facilitate this process are based upon traditional mail service and the tedium associated with processing hand written information. This can cause delays in and loss of deliveries or disruptions in services; all of which can have moderate to severe impacts, depending on the critical nature of the transaction. Businesses are not exempt from this same process and its ramifications.

In addition to this, consumer-to-consumer relationships are equally challenging. Consumers hold some form of directory, traditionally of written records, containing the public data for their various associations with other consumers. Many maintain numerous directories in different forms, which are becoming dominated by electronic devices such as desktop computers, personal data assistants, cellular telephones and network appliances. For each directory, regardless of form, the public data must be entered separately and thereby duplicated. Moreover, changes to any part of the public data must be propagated to each of these directories, in turn.

While attempts have been made to minimize the impact to businesses during this update process, the consumer is left with far too few options. Even with the latest business practice, which typically involves costly and relatively inaccurate data validation techniques, there is a tremendous need to centralize this public data, place its control and maintenance into the hands of the consumer and then make this public data available to businesses in a real-time environment.

Accordingly, the primary object of this invention is to make available to businesses and consumers alike, the current and correct consumer and business public data; while at the same time providing the tools these consumers and businesses need to maintain and control their respective public data.

Another object of this invention is to provide such a system in which a hierarchical directory, referred to as an “iSprocket Directory Service (iSDS)”, is realized on one or more data-synchronized iSDS Internet Systems for the purpose of housing all data items, be they public, associative or operative in nature; including, but not limited to: (i) a unique identification number, referred to as a “SKID,” assigned to each consumer or business; (ii) a consumers' or businesses' public data items consisting of (a) full name(s), (b) physical (or postal) address(es) (including mail drop for businesses), (c) telephone number(s), (d) electronic mail address(es), (e) uniform resource locator(s) and (f) a text description and keywords regarding a consumer or business; (iii) consumer or business relationship data items comprising lists of (a) businesses which have associations with a consumer, (b) consumers which have associations with a business and (c) consumers or businesses existing within the personal electronic address book(s) of this consumer or business; and (iv) additional SKIDs assigned to each data item, used in the manipulation of said public, associative or operative data items.

Another object of this invention is to provide such a system in which a relational database, referred to as an “iSDS Activity Log (iSAL)”, is realized on one or more data-synchronized iSDS Internet Systems for the purpose of recording the manipulation activities enacted upon the public data maintained within the iSDS; including, but not limited to: (i) a SKID associated with the consumer or business which requested the manipulation, (ii) a SKID associated with the public data proposed for manipulation, (iii) a SKID pointing to the exact public data item involved in the manipulation, (iv) the type of manipulation or action requested, (v) the outcome of the request, (vi) an explanation of the outcome, (vii) the date of the requests completion and (viii) the time of the requests completion.

Another object of this invention is to provide a novel method of constructing the hierarchical directory and relational database for use within the iSprocket Public Data Availability System that will provide for future expansion of the supported services; such as, for example, facilities for schedule management (using appointment data), Web navigation tracking (storing uniform resource locator histories), or online preferences (maintaining global settings for individuals), etc.

Another object of this invention is to create a novel and efficient method for connecting to the aforementioned iSDS by means of an interface which is comprised of a set of programmatically invoked routines, scripts or libraries, executed either (a) upon each iSDS Internet System or (b) upon the connecting environment, application or device, or (c) both, referred to as an “iSprocket Application Programming Interface (iAPI),” that provide the basic data access functions for item manipulation; such as direct reads using SKID's, searches using various criteria, item modification, sorting of retrieved items, logging of activity, etc.

Another object of this invention is to deliver an additional set of programs and programmatically invoked routines, scripts or libraries which utilizes the iAPI and is designed for specific business applications, referred to as an “iSDS Integration Kit (iSIK),” which provide the adaptations required to enable the software manufactured for the aforementioned business applications, to connect to the iSDS for utilization of the public data available on the iSDS Internet System.

Another object of this invention is to furnish a set of programs and programmatically invoked routines, scripts or libraries which utilize the iAPI and are designed for specific consumer applications, collectively referred to as an “iSprocket Application Plugin (iPIN),” which provide the additional capabilities required to enable the software manufactured for the aforementioned consumer applications to connect to the iSDS for utilization of the public data available on the iSDS Internet System.

Another object of this invention is to provide such a method of system integration in which a business system can be made to utilize the iSDS by means of (i) a continuous, high-speed and secure encrypted real-time Internet connection, referred to as a “virtual private network (VPN)”, to the iSDS Internet System, (ii) the iAPI, and (iii) the iSIK; thereby (a) reducing the associated cost of data storage and (b) over time, reclaiming those resources dedicated to the maintenance of this data, as more consumers actively update their own public data.

Another object of this invention is to build such a system whereas consumers or businesses can securely connect to the iSDS from anywhere at anytime, save that these connections support Internet networking and utilize either (a) an iPIN or (b) a Web browsing application, for the purposes of (i) maintaining their own public data stored therein; namely to (a) insert additional items, (b) modify existing items, (c) delete existing items, (d) define a default display of their public data, (e) manage centrally stored references to public data of consumers or businesses in their personal electronic ‘address books’ or (f) perform any other maintenance activity; (ii) retrieving and subsequently making use of the most current public data regarding a business or a consumer associate who has granted this consumer or business access to their public data and (iii) performing the initial registration process for new subscribers to the public data availability service.

Another object of this invention is to expand the aforementioned iSDS to include a control mechanism that will allow consumers and businesses to restrict access to their public data by other consumers and by businesses with which they do not hold a relationship; facilitated by additional data appended to the public data already stored therein; namely: (i) the SKID associated with the public data to which the suppression will be enacted and (ii) entries denoting a combination of (a) the degree of display suppression enacted upon the data, ranging from none to complete suppression, and (b) a SKID associated with a consumer or business to whom access restrictions are to be applied.

Another object of this invention is to provide a means for reporting on the various public data access activities for businesses, including, but not limited to, (i) the number of public data entries stored in the iSDS for each business, (ii) analysis of the number of updates performed by the business versus those made by the consumers, (iii) the amount of savings realized by the company in their local currency, (iv) the number of times the public data was accessed by the business, (v) details of which parties updated the public data associated with the business and (vi) accounts payable information, both current and historical, based upon iSDS resources used by the business.

Another object of this invention is to provide a means for reporting on the various public data access activities for consumers, including, but not limited to, (i) the number of times their public data was accessed and by whom, (ii) analysis of the security settings and their effect on access, (iii) the number of times access was requested from a restricted consumer or business and was subsequently authorized by the consumer and (iv) details of which parties updated the public data owned by the consumer.

Other features, advantages, and objects of the present invention will become apparent with reference to the following description and accompanying drawings.

### BRIEF DESCRIPTION OF DRAWINGS

FIG. 1 is a schematic diagram of a first illustrative embodiment of the iSprocket Public Data Availability System of the present invention shown embedded with the infrastructure of the global computer communications network, known as the “Internet”, and comprising a plurality of data-synchronized iSprocket Directory Service (iSDS) Internet Systems, a plurality of Web Servers, a plurality of Client Business Systems and a plurality of Consumer and Business Appliances, all connected to the infrastructure of the Internet.

FIG. 2 is a detailed schematic diagram of the business system connectivity component of the first illustrative embodiment of the iSprocket Public Data Availability System of the present invention, known as the “back-end”, shown rooted in the infrastructure of the Internet and comprising a plurality of data-synchronized iSDS Internet Systems and a plurality of Client Business Systems, all connected to the infrastructure of the Internet.

FIG. 3 is a detailed schematic diagram of the consumer and business connectivity component of the first illustrative embodiment of the iSprocket Public Data Availability System of the present invention, known as the “front-end”, shown situated within the infrastructure of the Internet and comprising a plurality of data-synchronized iSDS Internet Systems, a plurality of Web Servers and a plurality of Consumer and Business Appliances, all connected to the infrastructure of the Internet.

FIG. 4 is a an exemplary schematic representation of the hierarchical-type iSprocket Directory maintained by each iSDS Internet System that is configured into the iSprocket Public Data Availability System of the present invention, showing a method for geographically organizing and storing all consumer and business data items; including (i) the information required to secure connections, (ii) descriptions of and keywords regarding the business or consumer, (iii) criteria for controlling access to this same public data, (iv) resources held by business entities, (v) business relationships held by consumers, (vi) consumer relationships held by businesses and (vii) future expansion of the structure to make possible additional service capabilities.

FIG. 5 is a an exemplary schematic representation of the relational-type iSDS Activity Log (iSAL) database maintained by each iSDS Internet System that is configured into the iSprocket Public Data Availability System of the present invention, showing a method for storing information associated with the activities performed upon the data items, such as (i) who initiated the activity, (ii) whose data was requested, (iii) which specific data entries were requested, (iv) the type of activity requested, (v) details regarding the outcome of the request, (vi) specifics regarding when the request was completed and (vii) additional space reserved for future expansion of stored information.

### DETAILED DESCRIPTION OF THE INVENTION

Referring to the figures shown in the accompanying Illustrations, like structures and elements shown throughout the figures thereof shall be indicated with like reference numerals.

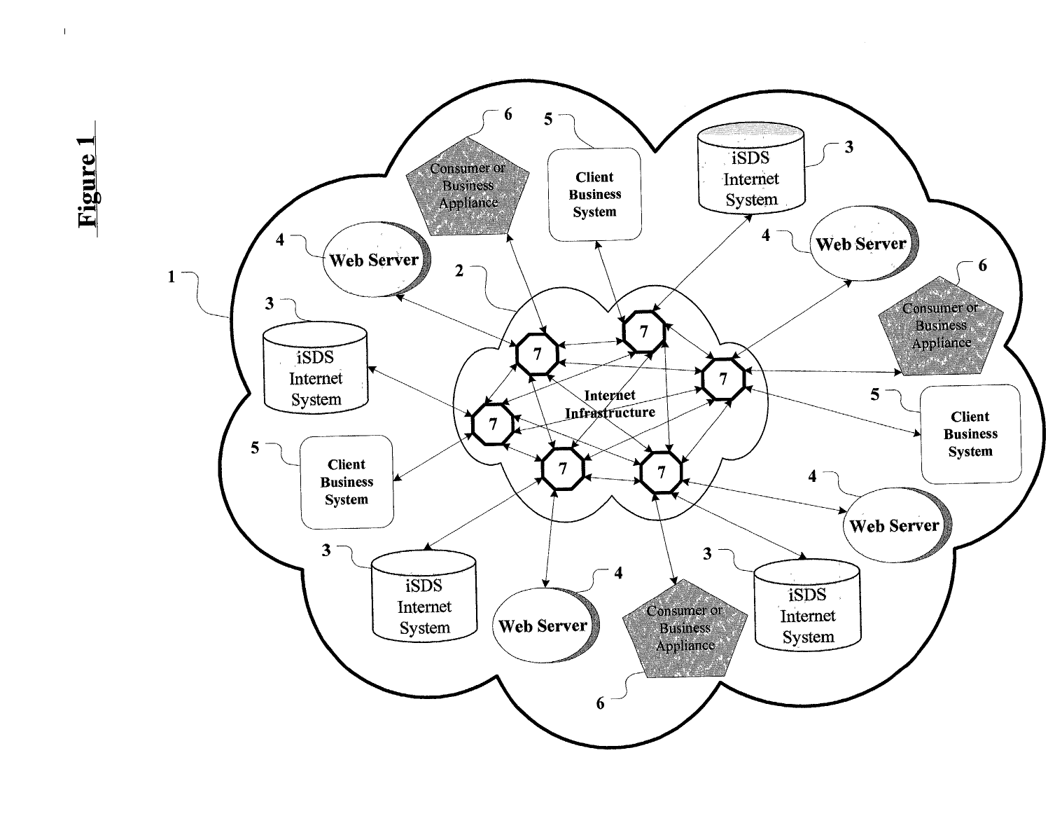

As shown in FIG. 1, the iSprocket Public Data Availability System of the present invention is generally indicated 1 and comprises an arrangement of system components, namely: a globally-based digital telecommunications network (such as the Internet) 2 having an infrastructure for supporting packet-switched type digital data telecommunications (including Internet Service Providers (ISPs), Network Service Providers (NSPs), routers, telecommunication lines, channels, etc.) using the TCP/IP networking protocol well known in the art; one or more iSprocket Directory Service (iSDS) Internet Systems 3, and being connected to the Internet at strategically different locations via the Internet infrastructure and data-synchronized with each other in order that each such System maintains a replicated directory structure; one or more Web Servers, each indicated by reference 4, and being connected to the Internet via the Internet infrastructure; a plurality of Client Business Systems 5, and being connected to the Internet via the Internet infrastructure; and a plurality of Consumer and Business Appliances 6, and being connected to the Internet via the Internet infrastructure.

In the illustrative embodiment, each synchronized iSDS Internet System 3 can be realized by, for example, the Windows 2000 Server® from Microsoft, Inc. or any other suitable computing machine that can perform the function of a Server in an Internet-based, client-server computer system architecture of the illustrative embodiment. As shown in FIG. 1, each iSDS Internet System 3 is interfaced with an ISP 7 in a conventional manner. The actual number of iSDS Internet Systems 3 used in any particular application will depend on various factors including, for example, user demand, Internet traffic conditions, network router capacity and performance, etc. Each such iSDS Internet System 3 is assigned a static TCP/IP address and a unique name on the Internet. Preferably, the synchronized iSDS Internet Systems 3 are maintained by a team of network managers under the supervision of one or more directory administrators.

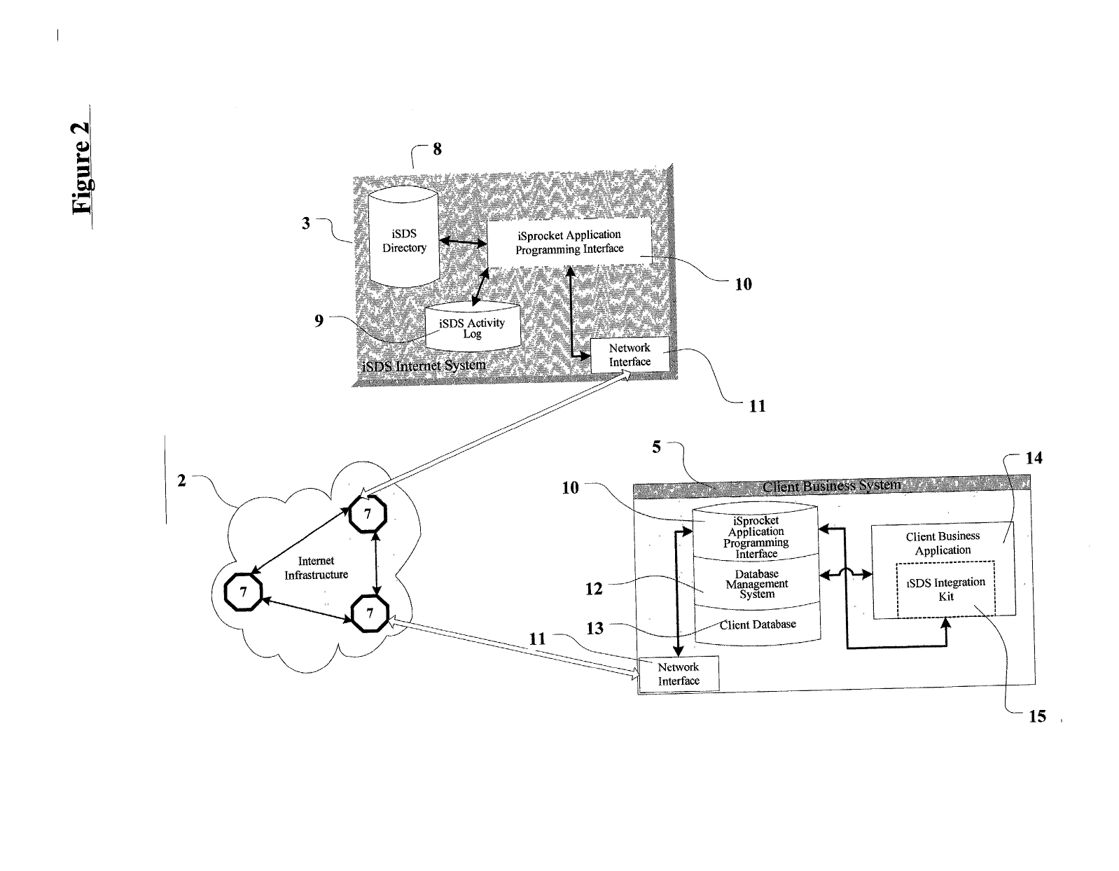

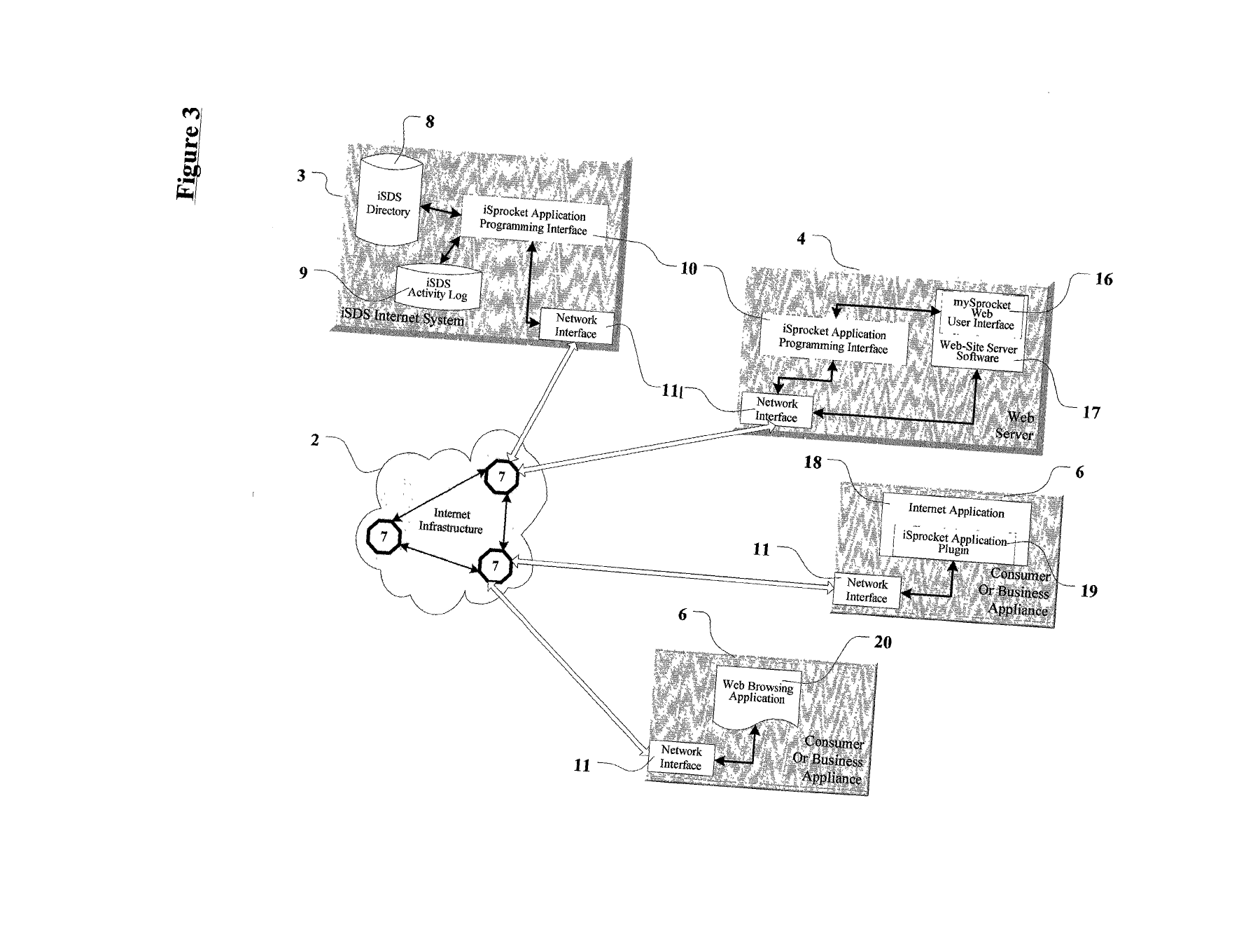

As shown in FIGS. 2 and 3, each iSDS Internet System 3 is also provided with (i) a hierarchical iSDS Directory and its associated management software 8 used to create and maintain all data items, (ii) a relational iSDS Activity Log (iSAL) database and its associated management software 9 to record details regarding all data manipulation events involving the iSDS Directory 8, (iii) an iSprocket Application Programming Interface (iAPI)10 providing programmatic connectivity to the iSDS Directory 8 and (iv) at least one Network Interface (including its associated Internet networking software)11 which supports at the least the TCP/IP, the Open Database Connectivity (ODBC) and the Lightweight Directory Access Protocol (LDAP) networking protocols, as well as VPN architecture.

In the illustrative embodiment, each Web Server 4 can be realized by, for example, the Windows 2000 Server® from Microsoft, Inc., the Solaris™ Operating Environment from Sun Microsystems or any other suitable computing machine that can perform the function of a Server in a web-based, client-server computer system architecture of the illustrative embodiment. As shown in FIG. 1, each Web Server 4 is interfaced with an ISP 7 in a conventional manner. The actual number of Web Servers 4 used in any particular application will depend on various factors including, for example, user demand, Internet traffic conditions, network router capacity and performance, etc. Each such Web Server 4 is assigned a static TCP/IP address and a unique name on the Internet. Preferably, the Web Servers are maintained by a team of network administrators under supervision of one or more webmasters.

As shown in FIG. 3, every Web Server 4 also contains, (i) a mySprocket Web User Interface (mWUI) service 16 providing an avenue for consumers and businesses to a manage their respective data items, (ii) Web-site Server Software 17 for creating and maintaining hypermedia-type Web-sites containing service related information of a multimedia nature, (iii) an IAPI 10 providing programmatic connectivity to the ISDS Internet System 3 and (iv) at least one Network Interface 11 to support at the least the TCP/IP, the Open Database Connectivity (ODBC) and the Lightweight Directory Access Protocol (LDAP) networking protocols. Such Web-sites can be expressed in HTML, XML, WML or any other suitable language, which allows for Web site construction, connectivity and functionality. Web-site management software, such as Microsoft® FrontPage™ or Adobe® GoLive!™, or any other suitable Web-site management software, can be used to maintain correct functionality for any particular Web site.

In the illustrative embodiment, each Client Business System 5 can be realized by any computing system that employs operating system (OS) software (e.g. Windows, Unix, etc.) that includes (i) Internet networking software, which supports at the least the TCP/IP and the LDAP networking protocols and (ii) programmatic modifications that support the connectivity between the Client Business System 5 and the iSDS Internet System 3 for the purpose of data exchange. As shown in FIG. 1, each Client Business System 5 is interfaced with an ISP 7 in a conventional manner. Each such Client Business System 5 may be assigned a static TCP/IP address and a unique name on the Internet, or one may be dynamically assigned thereto by way of its ISP 7, depending on its connectivity. Preferably, the Client Business Systems 5 are maintained by a team of application and network managers under supervision of one or more technical managers.

As shown in FIG. 2, each Client Business System 5 need also include (i) a plurality of Client Business Applications 14 that perform a set of specific business functions, (ii) an iAPI 10 for providing the connectivity to the iSDS Internet System 3, (iii) an iSDS Integration Kit (iSIK) 15 designed to provide each Client Business Application 14 with connectivity to the iAPI 10, (iv) a minimum of one Network Interface 11 to support at the least the TCP/IP, the Open Database Connectivity (ODBC) and the Lightweight Directory Access Protocol (LDAP) networking protocols, as well as VPN architecture, (v) a Client Database 13 where is stored and maintained the private data associated with the business-to-consumer or business-to-business relationships and (vi) Database Management System Software (DBMS) 12 used for processing of data requests issued to the Client Database 13. Each such Client Database 13 and its associated DBMS 12 should be relational in structure and can be expressed, for example in the Microsoft, Oracle or Sybase SQL language or any other language suitable for relational database management and connectivity.

In the illustrative embodiment, each Consumer or Business Appliance 6 can be realized by, for example, any of the following systems: (i) a computer system that employs operating system (OS) software (e.g. Windows, Unix, etc.), which supports a GUI-based Web browser interface, such as an Internet Browser program (e.g. Netscape® Navigator™, Microsoft® Internet Explorers™, etc.), and includes support for Internet networking software, which supports at the least the TCP/IP networking protocol; (ii) a computer system that employs operating system (OS) software (e.g. Windows, Unix, etc.), which supports desktop productivity software (e.g. Microsoft® Office Suite™, etc.) and includes support for Internet networking software, which supports at the least the TCP/IP networking protocol; (iii) a handheld computer system (e.g. 3COM® Palm™, etc.) which includes Internet networking software that supports at the least the TCP/IP networking protocol; or (iv) a wireless system, which includes Internet networking software that supports the digital or analog mobile services and networking protocols.

As shown in FIG. 1, each Consumer and Business Appliance 6 is interfaced with an ISP 7 in a conventional manner. Each such Consumer and Business Appliance 6 may be assigned a static TCP/IP address and a unique name on the Internet, or one may be dynamically assigned thereto by way of its ISP 7, depending on its connectivity. Typically, Consumer and Business Appliances 6 are maintained by consumers and/or potential consumers of products and/or services.

Also, as shown in FIG. 3, each of the Consumer and Business Appliances 6 will additionally contain (i) at least one Network Interface 11, to support Internet networking and at the least the TCP/IP networking protocol, and either (ii) an Internet Application 18 that makes use of public data and (a) its associated iSprocket Application Plugin 19 that provides a connection to the iSDS Internet System 3, or (iii) Web Browsing Application 20 used for interaction with Web-based information services.

In the illustrative embodiment of the present invention, each synchronized iSDS Internet System 3 of the preferred embodiment contains an iSDS Directory 8, as detailed in FIGS. 2 and 3, which can be expressed in the Novell® Directory Services language, Microsoft® Active Directory™ language or any other suitable directory language, which allows for directory programming and management, with connectivity and replicated synchronization over the Internet. Data synchronization among such directories can be achieved using conventional replication techniques well known in the art. In addition, a backup and mirroring strategy can be used to maintain data integrity.

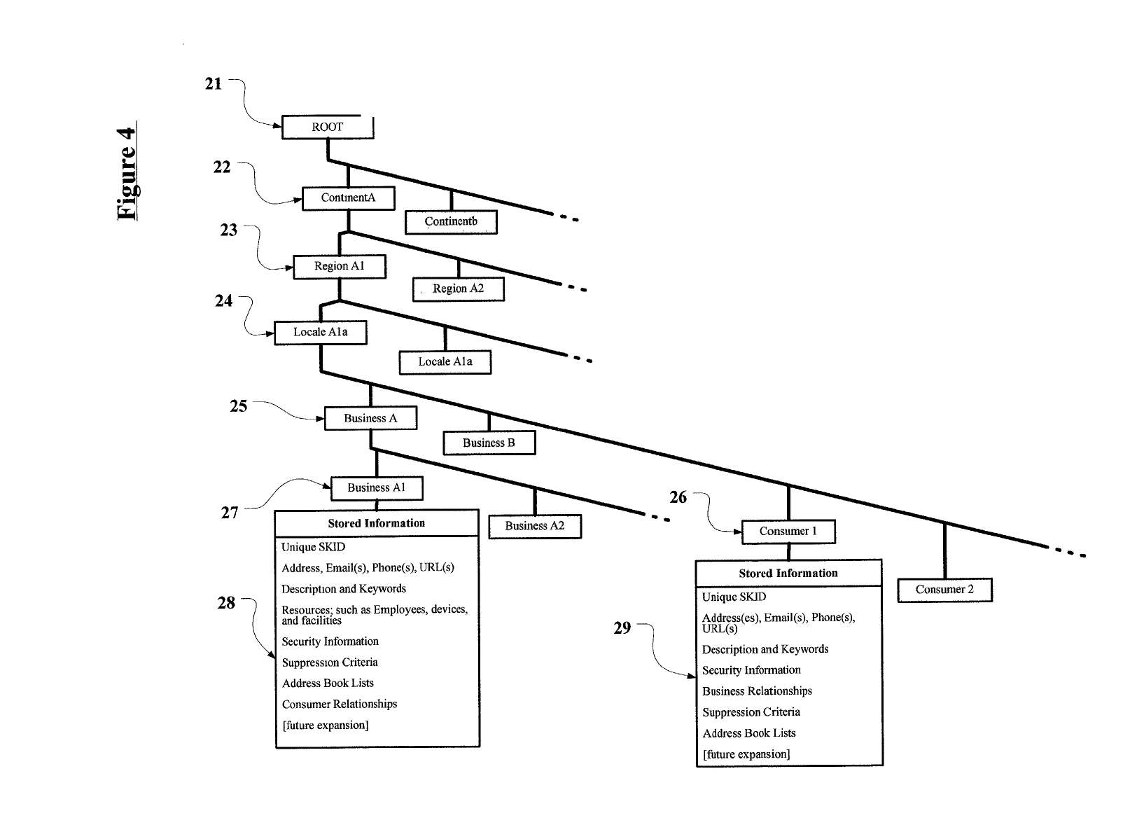

Each such iSDS Directory 8 maintains a hierarchical structure that can best be represented by a diagram, referred to as a “tree diagram”, that consists of (i) the starting point of data access, referred to as the “root”, and (ii) pathways for subsequent navigation which contain singular or multiple holders, referred to as “containers”, and (iii) specific entries, referred to as “leaves”. An example of how this structure might look is shown in FIG. 4.

As illustrated in FIG. 4, the hierarchical-type iSprocket Directory maintained by each iSDS Internet System comprises a plurality of containers stemming from the root 21 and having a one-to-one correspondence with a singular geographical continent 22 sprouting branches of containers which provide further subdivision into geographical regions 23 that additionally sprout branches of containers to finally subdivide the geographical regions into geographical locales 24.

Within each geographical locale 24, as shown in FIG. 4, branches a plurality of containers, which correspond to business public data entities 25 or consumer public data entities 26.

The business entities 25, as shown in FIG. 4, each sprout one or many containers, which represent subdivisions or subsidiaries of the business entity itself 27. Subsequently, each business entity subdivision or subsidiary sprout one or more containers or leaves 28 that store the data items unique to the business entity subdivision or subsidiary; namely, (i) a unique identifier or SKID, (ii) postal address(es), (iii) email address(es), (iv) telephone number(s), (v) Web address(es) or URL(s), (vi) description and keywords, (vii) resources owned and operated by the business, (viii) security information, (ix) suppression criteria, (x) address book lists of consumer and business associates, (xi) details of the consumer relationships held by the business and (xii) space reserved for future expansion.

As shown in FIG. 4, consumer public data entities 26 likewise sprout one or more containers 29 that store the data items unique to that particular consumer public data entity; namely, (i) a unique identifier or SKID, (ii) postal address, (iii) email address(es), (iv) telephone number(s), (v) Web address(es) or URL(s), (vi) description and keywords, (vii) security information, (viii) details of the business relationships held by the consumer, (ix) suppression criteria, (x) address book lists of consumer and business associates and (xi) space reserved for future expansion. Each consumer public data entity 26 can hold a plurality of unique combinations of data items 29, each assigned its own unique identifier or SKID, enabling consumers the flexibility to maintain numerous public identities, referred to as “profiles”. Common profiles would be maintained for home, office, business relationships, etc. with each separate profile a distinct representation of the consumer to whom the profile belongs.

In the illustrative embodiment of the present invention, each synchronized iSDS Internet System 3 of the preferred embodiment maintains its own iSDS Activity Log (iSAL) 9 database, as detailed in FIGS. 2 and 3. Each iSAL 9 relational database can be expressed in the Microsoft®, Oracle® or Sybase SQL language or any other language suitable for relational database programming, management and Internet connectivity. A backup and mirroring strategy can be used to maintain data integrity.

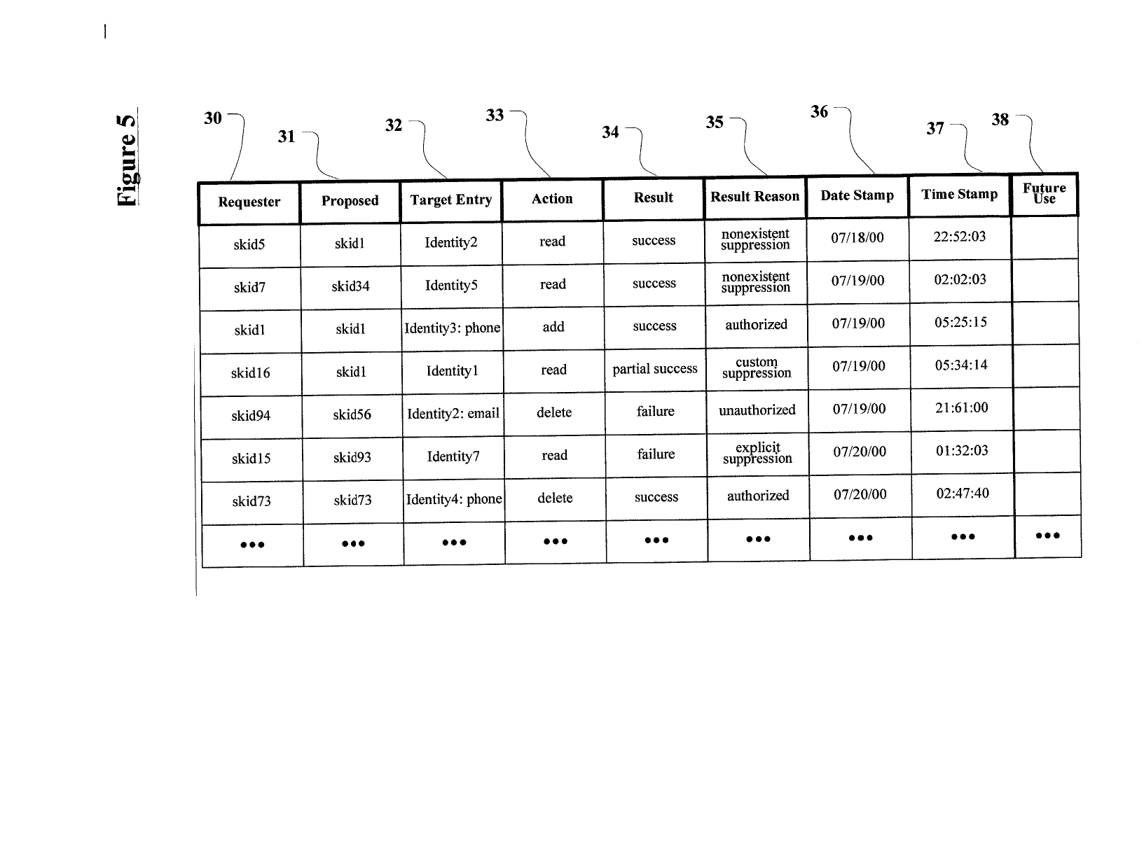

This iSAL 9 relational database structure is represented by a diagram, referred to as a “table diagram”, that consists of (i) columns for detailing each field of the database and (ii) rows denoting records containing specific values for each field. An example of how this structure might look is shown in FIG. 5.

As illustrated in FIG. 5, the relational-type iSAL 9 database maintained by each iSDS Internet System 3 comprises a plurality of columns in which all activity information is contained. Each of these columns holds details regarding which business or consumer requested the public data 30, the proposed business or consumer whose public data was to be acted upon 31, the specific public data item of the proposed business or consumer 31 targeted by the request 32, the action intended to be taken 33 upon this specific public data item 32, the outcome of the request 34, a text description of this outcome 35, the date upon which the request was completed 36, the time upon which the request was completed 37, and space reserved for future expansion of the database structure 38.

A suitable development instrument for creating the iSprocket Application Programming Interface (iAPI) 10 back-end component that operates on the iSDS Internet System 3, as shown in FIGS. 2 and 3, is the ‘C’ and ‘C++’ programming languages, ‘Visual Basic™’ programming language, ‘Java’ programming language or any other appropriate programming language that allows for creation of programmatically invoked routines, scripts or libraries used to interact with the iSDS Directory 8 and the iSAL 9 database in a conventional manner, for the purposes of (i) performance enhancements for data access and manipulation, (ii) maintaining data integrity, (iii) satisfying read access intensive requests made of the iSDS Directory, such as searches by name or address, (iv) generating detailed activity entries and inserting them into the iSAL database 9 and (v) generating activity reports and accounts receivable information.

For the creation of the mySprocket Web User Interface (mWUI) 16 front-end component, as shown in FIG. 3, viable development technologies include Microsoft Active Server Pages, HTML, XML, VML, ActiveX, Java programming language, JavaScript scripting language, Visual Basic programming language, VBScript scripting language or any other suitable programming or scripting technology that allows for the creation of a user interface which operates in conjunction with Web-Site Server Software 17 and interacts with the iSDS Directory 8 by means of the iAPI 10, for the purposes of (i) completing the initial service member registration process, (ii) maintaining public data profiles (including access restrictions) (iii) customizing or updating the service member authentication credentials, (iv) viewing of utilization analysis reports, (v) retrieval of an appropriate iPIN 19 which enables a Consumer or Business Appliance 6 to use the service and (vi) providing an avenue for service members to (a) give feedback, (b) view contact details for iSprocket business units and (c) receive customer support.

For the creation of the iSprocket Application Programming Interface (iAPI) 10 component that operates on the Web Server 4, as shown in FIG. 3, suitable development tools consist of the ‘C’ and ‘C++’ programming languages, Java programming language, JavaScript scripting language, Visual Basic programming language, VBScript scripting language or any other suitable programming or scripting technology that allows for the creation of programmatically invoked routines, scripts or libraries which provide interaction with the iSDS Internet System 3, iSDS Directory 8 and iSAL Database 9, for the purposes of, (i) establishment of an authenticated, secure session, (ii) retrieval of data items for use in the mWUI 16 service, (iii) insertion of new or updated data items, (iv) updates to authentication credentials, (v) alterations to the default views of public data profiles, (vi) creation and insertion of activity records, (vii) customization of data item access restrictions, (viii) retrieval of service member activity and data utilization details for subsequent report display and (ix) future expansion of the types of services provided by the iAPI 10.

A viable development mechanism for creating the iSprocket Application Programming Interface (iAPI) 10 back-end component that operates on the Client Business System 5, as shown in FIG. 2, is the, ‘C’ and ‘C++’ programming languages, Visual Basic programming language, Java programming language or any other suitable programming language that allows for the creation of programmatically invoked routine libraries stored outside the Client Database Management System 12, known as “external routines”, for the purpose of interacting with the iSDS Directory 8 and the iSAL Database 9.

A suitable development environment for construction of the iSDS Integration Kit (iSIK) 15 is the PL/SQL programming language, ‘C’ programming language, Java programming language or any other programming language the provides for the creation of programmatically invoked routines which are executed either by (i) the Client Database Management System 12 or (ii) the Client Business Application 14, extending the capabilities of the Client Business Application to invoke the aforementioned external routines of the iAPI 10, providing interaction with the iSDS Directory 8.

For the creation of the isprocket Application Plugin (iPIN) 19 front-end components, as shown in FIG. 3, viable development tools are the Visual C++ programming languages, Visual Basic programming language, Java programming language or any other suitable programming language that allows for the creation of components which integrate into the Microsoft Office Suite and 3COM PalmOS applications, for the purposes of (i) providing an application that guides the user, referred to as a “wizard”, through the initial service member registration process, (ii) maintenance of public data profiles, (iii) customizing or updating the service member authentication credentials, (iv) retrieval of public data information utilized within the applications, (v) viewing of utilization analysis reports, (vi) creation and insertion of activity records, and (vii) providing an avenue for service members to (a) give feedback, (b) view contact details for iSprocket business units and (c) receive customer support.

The iPIN 19 component which integrates with Microsoft Office Suite applications can be developed using such tools as the Visual Basic programming language, Visual C++ programming language, ‘C’ and ‘C++’ programming languages, ActiveX, COM Add-in or any other suitable programming language or technology that allows for programmatically extending the capabilities of these applications to incorporate the service.

The iPIN 19 component which provides integration for the PalmOS can be developed using such tools as the Visual C++ programming language, Java programming language, PalmOS SDK, PalmOS CDK or any other suitable programming language or environment that provides for the creation of applications and programmatically invoked routines or libraries summarily used to incorporate the service; namely (i) Palm Desktop applications that interact with the iSDS Directory 8 via the iAPI 10; (ii) Palm OS applications which (a) emulate the Palm Desktop applications upon the Palm computing device and (b) utilize synchronized copies of the public data managed by the Palm Desktop applications; and (ii) Palm OS conduits that perform the synchronization between the data stored on the Palm Desktop and that stored upon the Palm computing device.

As described above and shown in FIG. 2 a prospective business client must utilize a Client Business System 5 executing a Client Business Application 14 for which an associated iSIK 15 has been developed. To integrate this business client into the iSprocket Public Data Availability System, necessary procedures will be performed to allow for the incorporation of (i) the iAPI 10 into the Client Business System 5 and (ii) the iSIK 15 into the Client Business Application 14. At the same time, a secure, high-speed, encrypted VPN Internet connection, well known in the art, will be installed between the business clients' production computing facility and the iSDS Internet System 3; thereby laying the foundation for the back-end connection to the iSDS Directory 8.

While the programmatic integration of the Client Business Application 14 and the installation of the Internet connection are being performed, all public data will be removed from the Client Database 13, run through a normalization process to reformat the data for inclusion in the iSDS Directory 8 and subsequently populated into separate directory spaces for each processed entity. As data is removed from the Client Database 13, it is replaced by the profile SKID associated with the entity whose private data remains in the Client Database 13, to provide the link between this private data and the public data of this same entity. The SKIDs will also be used by the iSIK 15 when communicating with the iAPI 10 for subsequent interaction with the iSDS Directory 8.

These integration and normalization processes also provide (i) for the business client (a) generation of authentication credentials and (b) population of the business client data items into the iSDS Directory 8, consisting of subdivision or subsidiary entities of the business; and (ii) for each of the entities extracted from the Client Database 13 (a) generation of authentication credentials and (b) assignment of SKIDs for all public data profiles.

Typically, and especially for a business client with large numbers of consumers, the integration process will be performed within a duplicate construction of the business clients' production environment, so that when an agreed upon date for a cutover implementation is reached, the modified Client Business System 5 and its associated iSIK 15 from the duplicate production environment will be transferred into the business clients' production computing facility. Concurrently, the public data will be removed from the Client Database 13, archived and replaced with SKIDs.

At this point, the client will become an active participant in the iSprocket Public Data Availability System. For each of these integrated business clients, authentication credentials will be issued to them at the conclusion of the integration process, allowing the business client to register with the service and subsequently manage their associated data items; including the subdivision or subsidiary entities of their business.

In addition, each consumer that holds a relationship with the aforementioned business client will be encouraged to maintain their own public data by being notified of their authentication credentials and given instructions on how to register with the service. Using their credentials, a Consumer or Business Appliance 6 and a Web Browsing Application 20, as shown in FIG. 3, the consumer will use a conventional means to establish a secure connection to the mWUI 16, available on the Web Server 4. Once connected and authenticated, the consumer will initiate their own customized set of public data profiles by entering all combinations of their public data. At this time, they can also define a default view of their public data profiles and set restrictions on the use of these same public data profiles by other business client and consumer service members.

As an added benefit, any service member can utilize the address book synchronization capabilities of the service by retrieving and installing the appropriate iPINs 19 that enable their Internet Applications 18, as shown in FIG. 3. After this has been completed, the service member would process the personal electronic address books from the enabled Internet Applications 18 to update the entries contained therein with current public data values. This process also stores the entries of these address books in the iSDS Directory 8 in two ways; (i) within the service members directory space as a list of SKIDs associated with the public data of the entries in the personal electronic address book and (ii), in the case of personal electronic address book entries for consumers or businesses who are not service members, within a new directory space allocated for the non-member consumer or business and having access restricted to the service member whose personal electronic address book entry was used to create the new directory space. In the latter case, should the non-member consumer or business register with the service, this same directory space can be used for the management of their public data profiles.

To illustrate the practice of utilizing the iSprocket Public Data Availability System by a business client, we can look at an example of the processes common to many of the Business Client Applications 14 that use public data; such as billing or mass mailing applications. Each of these common processes is designed to act upon a subset of the businesses entire customer set. This selection is based upon a criterion that specifies a unique set of values contained within the private data items residing in the Client Database 13 (e.g. a customer must have an active account with a balance that is due and payable to qualify for process by the billing application), as shown in FIG. 2. This type of selection process is unchanged by the iSIK 15 which only affects how the application retrieves the public data used in the applications output processes. Once the application has determined the subset of customers to process, the changes introduced by the iSIK 15 allow the application to use the SKID from the Client Database 13 for each selected customer to obtain the public data from the iSDS Directory 8, via the iAPI 10, for subsequent output processing.

A similar situation exists for customer management applications that typically administer customer information via fields on a graphical user interface shown on a computer screen, allowing the user to make alterations, if necessary, to the field values. To request a computer screen display of the details for a customer, a user would input some piece of private data associated with that customer, such as an account number, into the application. As before, the customer management application accesses the Client Database 13 for population of the screen fields with private data; as shown in FIG. 2. However, the changes introduced by the iSIK 15 allow the application to use the SKID from the Client Database 13 to obtain the public data from the iSDS Directory 8, via the iAPI 10, for screen field population.

In addition, the iAPI 10 provides the added functionality of satisfying public data search requests issued by Client Business Applications 14, as shown in FIG. 2. These applications generate the search criteria and, by means of changes introduced by the iSIK 15, pass this criterion to the iAPI 10. Next, the iAPI 10 performs the search upon data items stored in the iSDS Directory 8 for this specific business, returning the results in a format that is expected by the application that initially generated the request.

Use of the iSprocket Public Data Availability System by a consumer service member is exemplified by the processes used for an Internet Application 18 that manages electronic mail, as shown in FIG. 3. These processes typically maintain lists of names and electronic mail addresses for use within the application. When the iPIN 19 is installed, the address list stored within the application is processed to determine the SKIDs that are associated with the iSDS Directory 8 public data profiles which correlate to the addresses in the list. These correlated SKIDs are stored locally with the application for subsequent use by the iPIN 19. During message composition, for new and reply correspondence, the user must specify the addresses for all recipients by either directly typing the recipient name in the address field of the composition or selecting this name from the list of addresses maintained by the application. Regardless of how the user specifies the intended delivery addresses, once the name is typed or highlighted from the list, the iPIN 19 uses the locally stored and correlated SKID to obtain the electronic address values of the associated public data item on the iSDS Directory 8 by passing the SKID to the iAPI 10 along with the request for the values. The data items returned are compared to the typed or highlighted addresses and if they are found to be more current, based upon the last date of change or other criteria, are used to replace the addresses in the composition and list.

A similar situation exists when using the ‘Mail Merge’ function of Microsoft Word, since it also has the capability of accessing a list of postal addresses maintained by the application. Once a user has created the document to be merged with the addresses, the user then selects names from the list of postal addresses for inclusion in the merge process. As each name is selected, the iPIN 19, having previously processed these address lists during installation, uses the locally stored and correlated SKID to obtain the postal address values of the associated public data item on the iSDS Directory 8 by passing the SKID to the iAPI 10 along with the request for the values, as shown in FIG. 3. The data item returned is compared to the selected address and if found to be more current, based upon the last date of change or other criteria, is used to replace the addresses in the merged document and list.

As an added feature of the services provided by the iSprocket Public Data Availability System, address lists maintained by members in iSDS Directory-enabled applications can be synchronized between all of their iSDS Directory-enabled applications and devices, such as the PalmOS Address Book. At any time, a service member can import their lists into the iSDS Directory 8 where they are stored and consolidated into one master address list. Then, this list can be propagated to each of their iSDS Directory-enabled applications and devices. In this way, the member has virtually unlimited access to the latest public data items for names maintained in their address list.

We claim:

1. Apparatus for administering a system for providing real time public data for a plurality of individual users and business users wherein said users can securely access, maintain, update, and monitor said public data, said apparatus comprising:
a plurality of data-synchronized directory service system units embedded within the infrastructure of a globally-based digital telecommunications network and connected thereto;
a plurality of globally-based digital telecommunications network-based information service units embedded within the infrastructure of a globally-based digital telecommunications network and connected thereto;
a plurality of client business system units embedded within the infrastructure of a globally-based digital telecommunications network and connected thereto;
a plurality of user appliance units embedded within the infrastructure of a globally-based digital telecommunications network and connected thereto; and
memory for storing said globally-based digital telecommunications network-based server units, said client business system units, and said user appliance units.

2. The apparatus of claim 1 wherein each said client business system unit further comprises:
at least one network interface unit for linking said client business system unit to said globally-based digital telecommunications network;
at least one application programming interface unit for providing connectivity to said data-synchronized directory service system units;
at least one business application unit for performing a set of specific business functions;
at least one database management unit for processing specific business data functions;
at least one client database unit for storing and maintaining private data associated with user relationships, said client database unit being relationally and connectively compatible with said database management unit; and
at least one integration unit for linking each said business application unit to said application programming interface.

3. The apparatus of claim 1 wherein each said data-synchronized directory service system unit further comprises:
at least one network interface unit for linking said data-synchronized directory service system unit to said globally-based digital telecommunications network;
at least one hierarchical directory unit for creating and maintaining all of said data-synchronized directory service system unit data;
at least one directory service activity log unit for recording details of all data manipulation events of said data-synchronized directory service system unit data; and
at least one application programming interface unit for programmic connectivity to said data-synchronized directory service system unit data.

4. The apparatus of claim 1 wherein each said user appliance unit further comprises:
at least one network interface unit for linking said user appliance unit to said globally-based digital telecommunications network;
at least one globally-based digital telecommunications network application unit for accessing said public data; and
at least one of (a) application plugin unit associated with said application unit for connecting to said network interface unit, and (b) globally-based digital telecommunications network browsing application unit for interaction with globally-based digital telecommunications network information services.

5. The apparatus of claim 1 wherein each said globally-based digital telecommunications network-based server unit further comprises:
at least one network interface unit for linking said globally-based digital telecommunications network-based server unit to said globally-based digital telecommunications network;
at least one user interface unit for managing user data items;
at least one globally-based digital telecommunications network processing unit for creating and maintaining globally-based digital telecommunications network-sites containing service related information of a multimedia nature; and
at least one application programming interface unit for programmic connectivity to said data-synchronized directory service system data.

6. The apparatus of claim 3 wherein each said hierarchical directory unit further comprises:
at least one root data directory unit;
a plurality of geographically continent specific container units connected to each said root data directory unit;
a plurality of geographically regional specific container units connected to each said geographically continent specific container unit;
a plurality of geographically locale specific container units connected to each said geographically regional specific container unit;
a plurality of business public data entity container units connected to each said geographically locale specific container unit, wherein each such business public data entity container unit has at least one subdivision unit, wherein each said subdivision unit further comprises a unique identification unit, a postal address unit, an electronic mail address unit, a telephone number address unit, a uniform resource locator address unit, a keyword unit, a business resource unit, a consumer relationship unit, and a reserved space unit; and
a plurality of consumer public data entity container units connected to each said geographically locale specific container unit, wherein each such consumer public data entity container unit further comprises a unique identification unit, a postal address unit, an electronic mail address unit, a telephone number address unit, a uniform resource locator address unit, a keyword unit, a security information unit, a business relationship unit, a suppression criteria unit, an address book unit, and a reserved space unit.

7. The apparatus of claim 2 wherein each said client database unit for storing and maintaining private data associated with user relationships further comprises a data requester identification unit, a data target identification unit, a targeted data item identification unit, an intended action unit, a request outcome unit, an outcome text unit, a request completion date unit, a request completion time unit, and a reserved space unit.

8. The apparatus of claim 1 wherein said globally-based digital telecommunications network is the Internet.

9. A data processing system for administering and providing real time public data for a plurality of individual users and business users according to the apparatus of claim 1 wherein said users can securely access, maintain, update, and monitor said public data, said system comprising:
means for providing globally based digital telecommunications having an infrastructure;
means for providing supporting packet-switched type digital data telecommunications within said globally based digital telecommunications means infrastructure;
means for providing a replicated directory structure within said globally based digital telecommunications means infrastructure;
means for storing said globally based digital telecommunications connectively within said globally based digital telecommunications means; and
means for user connection to said globally based digital telecommunications means through said infrastructure.

10. The data processing system of claim 9 wherein said means for providing a replicated directory structure includes a means for hierarchical directory structure, said system further comprising:
means for data access within each said globally-based digital telecommunications network-based server;
means for data manipulation within each said globally-based digital telecommunications network-based server;
means for maintaining data integrity within each said globally-based digital telecommunications network-based server;
means for satisfying read access intensive requests within each said globally-based digital telecommunications network-based server;
means for generating detailed activity entries within each said globally-based digital telecommunications network-based server;
means for inserting detailed activity entries into a database within each said globally-based digital telecommunications network-based server;
means for generating activity reports within each said globally-based digital telecommunications network-based server;
means for generating accounts receivable data within each said globally-based digital telecommunications network-based server; and
wherein said means for hierarchical directory structure further comprises;
means to provide at least one root data directory;
means to provide a plurality of geographically continent specific containers connected to each said root data directory;
means to provide a plurality of geographically regional specific containers connected to each said geographically continent specific container;
means to provide a plurality of geographically locale specific containers connected to each said geographically regional specific container;
means to provide a plurality of business public data entity containers connected to each said geographically locale specific container, wherein each such business public data entity container unit has at least one means to provide a subdivision, wherein each said subdivision further comprises a means to provide a unique identification, a postal address, an electronic mail address, a telephone number address, a uniform resource locator address, a keyword, a business resource, a consumer relationship, and reserved space; and
means to provide a plurality of consumer public data entity containers connected to each said geographically locale specific container, wherein each such consumer public data entity container further comprises a unique identification, a postal address, an electronic mail address, a telephone number address, a uniform resource locator address, a keyword, a security information, a business relationship, a suppression criteria, an address book, and a reserved space.

11. The data processing system of claim 9 wherein said means for storing said globally based digital telecommunications connectively within said globally based digital telecommunications means includes means for a front-end interface with said globally based digital telecommunications means, said system further comprising:
means for completing initial service member registration;
means for maintaining public data profiles;
means for customizing service member authentication credentials;
means for updating service member authentication credentials;
means for viewing utilization analysis reports;
means for retrieval of a personal identification number providing access to the system; and
means for service member communication within said system.

12. The data processing system of claim 11 wherein said means for storing said globally based digital telecommunications connectively within said globally based digital telecommunications means includes means for an application program interface with said globally based digital telecommunications means, said system further comprising:
means to establish an authenticated, secure session;
means to retrieve data items for service member use;
means to insert at least one of (a) new data items and (b) updated data items;
means to update authentication credentials;
means to alter default views of public data profiles;
means to adjust activity records by providing at least one of (a) creation of said record, and (b) insertion of said record;
means to customize data item access restrictions;
means to retrieve at least one of (a) service member activity, and (b) data utilization details for subsequent report display; and
means to provide capacity for future expansion of additional services.

13. The data processing system of claim 12 wherein said means for an application program interface with said globally based digital telecommunications means includes means for a back-end interface with said globally based digital telecommunications means, said system further comprising:
means for programmatically invoked routines which are executed by a client database management system;
means for programmatically invoked routines which are executed by a client business application;
means for interacting said replicated directory structure through invocation of at least one of (a) said programmatically invoked routines which are executed by a client database management system, and (b) said programmatically invoked routines which are executed by a client business application.

14. The data processing system of claim 9 wherein said means for user connection to said globally based digital telecommunications means through said infrastructure includes an application plug-in, said system further comprising:
means for guiding the user through initial service member registration process;
means for maintenance of public data profiles;
means for customizing service member authentication credentials;
means for updating service member authentication credentials;
means for retrieval of public data information utilized within the applications;
means for viewing utilization analysis reports;
means for creation of activity records;
means for insertion of activity records; and
means for service member communication within said system.

15. The data processing system of claim 10 wherein said means for generating detailed activity entries within each said globally-based digital telecommunications network-based server further comprises:
means for a data requester identification;
means for a data target identification;
means for a targeted data item identification;
means for an intended action;
means for a request outcome;
means for an outcome text;
means for a request completion date;
means for a request completion time; and
means for reserved space.

16. A data processing method for administering a plan for providing real time public data for a plurality of business users wherein said business users can securely access, maintain, update, and monitor said public data, said method comprising the steps of:
registering a client business using a client business system unit;
integrating said client business into the public data availability system by incorporating an application programming interface unit for said client business into a client business system;
integrating said client business into the public data availability system by incorporating integration kit unit into said application programming interface unit;
installing a secure client business connection between said client business' production computing facility and a globally-based digital telecommunications network;
inputting the client business account number using said client business system;
selecting a client business application using an application programming unit;
generating the client business application criteria using said application unit;
generating the client business search criteria using said application unit;
searching the data base for the client business records responsive to said application criteria and said search criteria using a client business database management unit;
obtaining the desired client business records;
performing the desired function with respect to said client business records using said application unit;
storing the client business records using a client business data base unit;

17. A data processing method for administering a plan for providing real time public data for a plurality of individual users wherein said individual users can securely access, maintain, update, and monitor said public data, said method comprising the steps of:
notifying said individual user of their authentication credentials;
providing said individual user with instructions on how to register with the plan;
establishing a secure connection to a web user interface unit;
authenticating said connection using said authentication credentials;
initiating said individual user's customized set of public data profiles;
synchronizing the capabilities of said individual user's address book using an application pug-in unit by at least one of (a) retrieving the appropriate plug-in applications and (b) installing the appropriate plug-in applications; updating user address books using a globally-based digital telecommunications network applications unit;
storing said address book entries into a directory unit using an globally-based digital telecommunications network applications unit by at least one of (a) as system member identification number and (b) as system non-member listings;
choosing an identification number within said directory unit;
requesting electronic address values associated with said identification number using said globally-based digital telecommunications network applications unit;
transferring said identification number and said requested electronic address values to an application program interface unit;
comparing said transferred requested electronic address values with corresponding stored values for said identification number; and
updating said electronic address values associated with said identification number with the most current values for said identification number.
